(19) United States
(12) Patent Application Publication
(10) Pub. No.: US 2024/0388194 A1
(43) Pub. Date: Nov. 21, 2024

(54) METHOD FOR PREVENTING FLICKER EMISSIONS OF CONVERTERS

(71) Applicant: Siemens Aktiengesellschaft, 80333 München (DE)

(72) Inventor: BENNO WEIS, Hemhofen (DE)

(73) Assignee: Siemens Aktiengesellschaft, 80333 München (DE)

(21) Appl. No.: 18/688,173

(22) PCT Filed: Aug. 5, 2022
(86) PCT No.: PCT/EP2022/072043

§ 371 Date: Feb. 29, 2024

(30) Foreign Application Priority Data
Sep. 1, 2021 (EP) 21194379.0

(51) Int. Cl. H02M 1/12; H02M 1/00; H02M 1/15; H02M 1/32

(52) U.S. Cl. CPC H02M 1/12; H02M 1/007; H02M 1/15; H02M 1/32

(57) ABSTRACT

A converter includes a load converter for supplying an electric load, an active grid converter connected at a connection point to an electric power supply grid, and an intermediate circuit supplied by the active grid converter with an intermediate circuit voltage. Flicker emissions of the active grid converter on the power supply grid can be prevented by controlling the active grid converter so that a grid current change at the connection point maintains a maximum permissible change of effective values of successive voltage half-cycles of a voltage at the connection point by taking into account a grid impedance determined from a power grid analysis of the active grid converter at the connection point.

The invention relates to a method for preventing flicker emissions in electric power grids for active and passive grid power converters, as well as loads that can be connected to such a power grid.

Converters are devices that use electronic means to convert an alternating or three-phase voltage into a new alternating or three-phase voltage system.

A converter or frequency converter comprises a grid converter that rectifies the grid voltage for a DC link (“intermediate circuit”) and a load converter that converts the voltage of the DC link to AC for a consumer, i.e. a load.

Active grid converters, such as AFEs (Active Front Ends) for drive applications, adjust their DC link voltage U_{ZK} to a constant value. Changes in the power consumption of a connected load, e.g. a motor, are therefore directly reflected in the grid current I_{N} drawn by the converter. The grid current I_{N} causes a voltage change in the voltage U_{A} at the connection point A of the converter due to its voltage drop in the internal impedance Z_{N} of the grid. This means that load changes are directly visible in the voltage U_{A}.

Limit values for permissible changes in the rms value of successive half-cycles of the voltage U_{A} at connection point A must be maintained. The permissible amount of voltage variation depends on its frequency. A minimum permissible voltage variation is approx. 1000 changes per minute, i.e. 16.6 Hz. If these limit values are exceeded, the “flicker” phenomenon occurs.

This manifests itself in fluctuations in the brightness of lighting equipment that are harmful to health.

Flicker therefore refers to electrical voltage fluctuations in power grids, resulting in a visually perceptible fluctuation in the luminance of uncontrolled electrical light sources such as fluorescent lamps or incandescent lamps. In the case of sufficiently electronically controlled light sources, such as LED lights or compact fluorescent lamps, flicker is often not visually perceptible because of the ballast electronics.

Flicker phenomena are one of many criteria for assessing the voltage quality in power grids and evaluating grid perturbations from loads in such grids. Flicker refers to fluctuations in luminance that originate in the supply grid, while light flicker describes fluctuations in brightness that are caused by the design of the light source.

The operating voltage in power grids is subject to temporal fluctuations. Regular load fluctuations of larger loads result in fluctuating currents in the grid. Depending on the grid impedance, these current fluctuations cause a fluctuating voltage drop in the lines. Additional sources of voltage fluctuations are intermodulations in the harmonic range of the grid frequency which are caused by the distortive reactive power of non-linear loads.

If the connected load of a frequency converter exhibits periodic load changes resulting in voltage changes exceeding the flicker limit value in the voltage U_{A}, this installation must not be connected to the public power grid, e.g. a low-voltage grid.

Although no standardized flicker limit values apply in industrial installations, fluctuations in the brightness of lighting equipment also affect the health of workers in industrial installations.

In the current state of the art, installations subject to such load changes may only be connected to power grids in which the grid impedance Z_{N} is low enough to ensure that load changes do not result in impermissible voltage changes. Designing devices for this purpose is very complex and uncertain.

The object of the invention is therefore to provide a method for preventing flicker emissions of a converter connected to a power grid. In addition, devices equipped with such a converter are to be designed to prevent such flicker emissions.

This object is achieved by a method for preventing flicker emissions of an active grid converter connected to a power grid, wherein a converter comprises a load converter for supplying an electrical load, an active grid converter at a connection point A of the electrical power grid, for supplying a DC link with a DC link voltage U_{ZK} of the converter, wherein the DC link comprises at least one capacitor, by means of the following steps:
determining the grid impedance Z_{N} of the power grid from a power grid analysis of the active grid converter at the connection point A,
adjusting the active grid converter to a predefinable permissible grid current change ΔI_{N} at which permissible changes in the rms value of successive voltage half-cycles of the voltage U_{A} at the connection point A are maintained with respect to the grid impedance Z_{N}.

The basic concept of this invention is that the control system of the active grid converter no longer adjusts solely to a constant DC link voltage, but deliberately allows changes in the DC link voltage in order to prevent changes in the power consumption of the load, e.g. a motor, from becoming visible in the grid current I_{N}. The at least one DC link capacitor is used as an energy store to compensate for preferably small load changes.

According to the invention, the load converter therefore does not adjust its load—only the active grid converter does so. The difference in power between the two converters (active grid converter, load converter) results in a change in the voltage of the DC link capacitor, which is thus used as an energy buffer. This means that the load does not “see” any change in power and no additional energy storage is required in the DC link because the DC link capacitor is present anyway and inventively performs this energy storage function.

The grid impedance Z_{N} is known from a power grid analysis of the active grid converter.

According to the invention, the control system of the active grid converter now continuously calculates the maximum permissible grid current change ΔI_{N} at which the flicker limit values are still just maintained. The change in I_{N} is limited to this maximum permissible change.

The flicker limit values apply to the individual phase voltages at the connection point U_{A} with respect to the grid star point, because lighting equipment is generally connected in single phase.

In an advantageous embodiment of the invention, the permissible current changes are therefore calculated separately for all three phases.

The limiting of the current change I_{N} results in changes in the DC link voltage U_{ZK} of the converter. With increasing load changes, this can result in the DC link voltage reaching the switch-off threshold for overvoltage or undervoltage.

In this case, either load shutdown or breaching of the flicker limit values can be accepted.

In order to prevent this state for the subsequent operating time, the control system of the converter in this case inventively generates a warning message that e.g. an additional DC link capacitor should be connected or switched in, in order to avoid this conflict of objectives in future. The extent to which the permissible current change ΔI_{N} is exceeded can also be used to calculate how much additional DC link capacitance is required to compensate for such load fluctuations in the future.

In an advantageous solution according to the invention, this warning is not only issued when the switch-off threshold is reached, but even beforehand, e.g. at a 10% distance from the switch-off threshold.

In a further advantageous embodiment, the algorithm for calculating the changes in the grid current I_{N} in advance is implemented in design software for drives. This makes it possible to design the required DC link capacitance for a specific customer installation with expected load cycles and an expected grid impedance, with which flicker limit values can be maintained without shutdowns due to overvoltage or undervoltage.

The object can also be achieved by a method for preventing flicker emissions of a passive grid converter on a power grid,

wherein a converter comprises a load converter for supplying an electrical load, a passive grid converter at a connection point A of the electrical power grid, for supplying a DC link with a DC link voltage U_{ZN} of the converter, wherein the DC link has at least one capacitor, by means of the following steps:
storing local maxima of the DC link voltage U_{ZN} and determining therefrom the voltage fluctuation at the connection point A of the converter on the power grid,
adjusting the grid current I_{N} in order to keep the DC link voltage U_{ZN} within a range compliant with the flicker emissions by complying with the permissible changes in the rms value of successive voltage half-cycles of the voltage U_{A} at the connection point A.

The method according to the invention will thus also be used for passive grid converters with diode infeed. Since a passive diode rectifier does not generally recognize the grid impedance, it stores the local maxima of the DC link voltage. These correspond to the maxima of the grid voltage at connection point A. The voltage fluctuation at connection point A can be determined from the difference between these maxima.

The observation time for the changes in the voltage U_{A} is inventively limited, e.g. to a period of one second. This prevents changes in the ideal grid voltage U_{N} from being misinterpreted by other external loads as flicker emissions.

In order to further reduce such misinterpretations, the invention establishes a temporal correlation between changes in the DC link voltage and changes in the power at the load output. The voltage change is only interpreted as flicker if the changes in the DC link voltage also correlate timewise with power changes at this device output. This ensures that unbalances in the grid voltage are not interpreted as flicker.

Also in the case of the passive grid converter, limiting the current change I_{N} results in changes in the DC link voltage U_{ZK} of the converter. With increasing load changes, this can result in the DC link voltage reaching the switch-off threshold for overvoltage or undervoltage.

In this case, either load shutdown or breaching of the flicker limit values are acceptable.

In order to avoid this state of affairs for the subsequent operating time, the control system of the converter inventively generates a warning message in this case, e.g. to notify that an additional DC link capacitor should be connected or switched in, in order to avoid this conflict of objectives in the future. The extent to which the permissible current change Δ_{IN} is exceeded can also be used to calculate how much additional DC link capacitance is required to compensate for such load fluctuations in the future.

In an advantageous solution according to the invention, this warning is not only issued when the switch-off threshold is reached, but even beforehand, e.g. at a 10% distance from the switch-off threshold.

In a further advantageous embodiment, the algorithm for calculating the changes in the grid current I_{N} in advance is implemented in design software for drives. This makes it possible to design the required DC link capacitance for a specific customer installation with expected load cycles and an expected grid impedance, said capacitance enabling flicker limit values to be maintained without shutdowns due to overvoltage or undervoltage.

The object can also be achieved by using the methods according to the invention to control an active grid converter or to control a passive grid converter for single-phase loads, in particular household appliances, and three-phase loads, in particular electric drives.

The inventive solutions allow devices to be used in applications that are not currently possible. Customer complaints about flicker emissions can thus be averted.

In addition, the designing of electric drives is simplified for customers.

The object is also achieved by a converter comprising a load converter for supplying an electrical load, an active grid converter at a connection point A of an electrical power grid, for supplying a DC link of the converter, wherein the DC link has at least one capacitor, wherein the converter implements the method according to the invention in the case of an active grid converter in order to prevent impermissible flicker emissions.

The object is also achieved by a converter having a load converter for supplying an electrical load, a passive grid converter at a connection point A of an electrical power grid, for supplying a DC link of the converter, wherein the DC link has at least one capacitor, wherein the converter implements the method according to the invention in the case of a passive grid converter in order to prevent impermissible flicker emissions.

The object can also be achieved by electrical loads, such as electric drives, household appliances having a single-phase or three-phase converter according to the invention.

The invention and further advantageous embodiments of the invention will now be explained in more detail with reference to examples shown in the drawings in which:

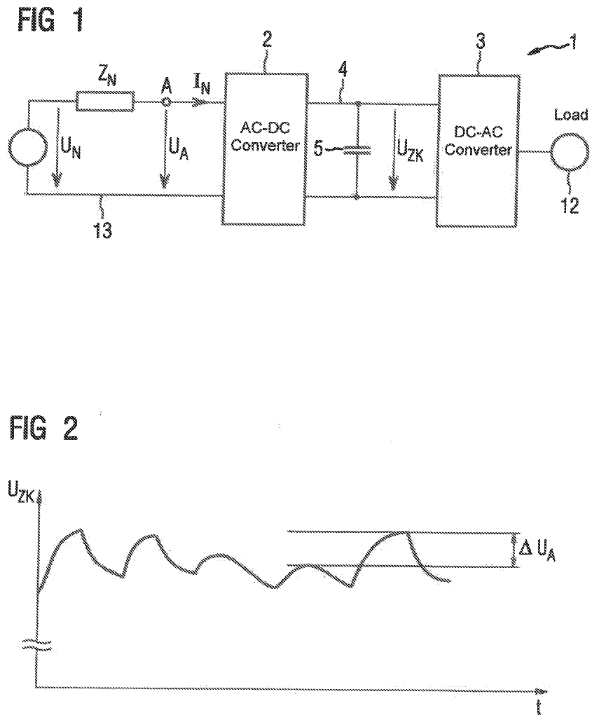

FIG. 1 schematically illustrates a load on a converter with active grid converter,

FIG. 2 shows determinations of voltage fluctuations on a converter having a passive grid converter.

FIG. 1 schematically illustrates a converter 1 with a load, e.g. a motor 12, and having an active grid converter 2 which rectifies a grid voltage U_{N} for a DC link 4 and a load converter 3 which converts the voltage of the DC link U_{ZK} to AC for the motor 12. The converter 1 is electrically connected to a power grid 13 at a connection point A and draws a grid current I_{N}.

Changes in the power consumption of the motor 12 are therefore directly reflected in the grid current I_{N} drawn by the converter 1. The grid current I_{N} causes a voltage change in the voltage U_{A} at the connection point A of the converter 1 due to its voltage drop in the internal impedance Z_{N} of the power grid 13. This means that load changes are directly visible in the voltage U_{A}.

The power grid 13 has a grid voltage U_{N} that requires a predefinable quality of grid voltage U_{N}, e.g. limit values for flicker phenomena.

According to the invention, the control system of the active grid converter 2 now no longer adjusts to a constant DC link voltage U_{ZK}, but allows changes in the DC link voltage U_{ZK} in order to prevent changes in the power consumption of the load, e.g. the motor 12, from becoming “visible” in the grid current I_{N} in such a way that flicker occurs. The DC link capacitor 5 is initially used as an energy store to compensate for load changes. However, this is not possible for every load change, so that the control system of the active grid converter 2 continuously determines the maximum permissible grid current change ΔI_{N} at which the flicker limit values are just maintained.

The change in the grid current I_{N} drawn is now limited to this maximum permissible change by the method according to the invention.

The grid impedance Z_{N} required for this purpose is known from a power grid analysis of the active grid converter 2 and constitutes an input parameter for the control system on the grid converter 2.

The flicker limit values to be maintained apply to the individual phase voltages at the connection point U_{A} with respect to the grid star point, because lighting equipment is generally connected in single phase.

In an advantageous embodiment of the invention, the permissible current changes ΔI_{N} are therefore calculated separately for all three phases of the power grid 13.

The method according to the invention is also suitable for special industrial grids that are not designed as single-phase or three-phase systems.

The method according to the invention for controlling an active grid converter is carried out as follows, as shown in FIG. 2:

In a first step, the grid impedance of the power grid 13 is first determined by means of the active grid converter 2 of the converter 1. Then, in a subsequent step, the maximum permissible grid current changes ΔI_{N} at which the specified flicker limit values are still maintained are continuously calculated for the load currently applied to the converter 1.

In a further step, the thereby changed DC link voltage U_{ZK} is checked to ascertain whether either the connected load, e.g. the motor 12, has been switched off or the specified flicker limit values have been breached or are accepted.

With increasing load changes, this can result in the DC link voltage reaching a switch-off threshold for overvoltage or undervoltage.

In order to avoid this state of affairs, in a further step a warning message is therefore sent in advance to the device and/or a higher-level control room, e.g. to provide/connect-in an additional DC link capacitor in order to avoid this conflict of objectives in the event of future load changes. The level of changes can be used to calculate the required size of the DC link capacitance.

Ideally, this warning message is sent before the switch-off threshold is reached, e.g. 10% before the switch-off threshold.

In order to avoid this state of affairs for the subsequent operating time of the load, the control system of the converter 1 in this case inventively generates the above-mentioned warnings that an additional DC link capacitor should be connected in order to avoid this conflict of objectives in future.

The extent to which the permissible current change ΔI_{N} is exceeded can also be used to calculate how much additional DC link capacitance needs to be provided in order to compensate for the (known) load fluctuations of this load on the converter 1 in the future.

In the case of a passive grid converter with diode feed into the DC link 4, flicker emissions are prevented as follows. (The schematic diagram of converter 1 applies accordingly). Since a passive diode rectifier is generally unaware of the grid impedance, it stores the local maxima of the DC link voltage as shown in FIG. 2. These correspond to the maxima of the grid voltage U_{N} at connection point A. The voltage fluctuation at connection point A can be determined from the difference between these maxima.

According to the invention, the observation time for the changes in the voltage U_{A} is limited e.g. to a period of one second. This prevents changes in the ideal grid voltage U_{N} from being misinterpreted as flicker emissions.

In order to further reduce corresponding misinterpretations of the operation of the converter 1, a time correlation between changes in the DC link voltage and changes in the power at the load output is inventively established. This voltage variation is interpreted as flicker only if the changes in the DC link voltage also correlate timewise with power changes at the converter output. This ensures that unbalances in the grid voltage caused by other loads are not interpreted as flicker.

Intervention in the control of the current I_{N} takes place only if there is a time correlation, i.e. the voltage change is due to load changes.

In principle—this applies to both the active and the passive grid converter—the grid voltage of the power grid 13 is rectified for the intermediate circuit 4, more precisely the DC link, and made available to the load converter 3, which converts the voltage of the DC link 4 into AC for a consumer, i.e. a load 12.

Individual features of the respective embodiments of the active or passive power converters can also be combined where appropriate without departing from the essential scope of the invention.

1.-8. (canceled)

9. A method for preventing flicker emissions in a converter, the converter comprising a DC-AC load converter for supplying an electrical load and an AC-DC active grid converter connected to a power grid at a connection point and supplying a DC link having at least one capacitor with a DC link voltage and operating as an energy store, the method comprising:
determining the grid impedance of the power grid from a power grid analysis of the AC-DC active grid converter at the connection point; and
controlling the active grid converter so that a grid current change at the connection point maintains a maximum permissible change of effective values of successive voltage half-cycles of a voltage at the connection point by taking into account the grid impedance, thereby preventing the flicker emissions of the AC-DC active grid converter.

10. The method of claim 9, further comprising triggering a warning message when the DC link voltage reaches a switch-off threshold caused by an increase in the electrical load.

11. The method of claim 9, wherein the warning message is triggered when the DC link voltage is less than or greater than a switch-off threshold by a predetermined offset voltage.

12. The method of claim 11, wherein the predetermined offset voltage is 10% of the switch-off threshold.

13. The method of claim 9, wherein the electrical load is a single-phase electrical load and the power grid is a public power grid or an industrial power grid.

14. The method of claim 9, wherein the electrical load is a three-phase electrical load and the power grid is a public power grid or an industrial power grid, and wherein the grid converter is controlled for each of the three phases.

15. The method of claim 13, wherein the single-phase electrical load comprises a household appliance.

16. The method of claim 14, wherein the three-phase electrical load comprises an electric drive.

17. A converter, comprising:
a DC-AC load converter for supplying an electrical load;
an AC-DC active grid converter having a connection point connected to an electrical power grid; and
a DC link connecting the DC-AC load converter and the AC-DC active grid converter and comprising at least one capacitor operating as an energy store, wherein the AC-DC active grid converter is controlled so that a grid current change at the connection point maintains a maximum permissible change of effective values of successive voltage half-cycles of a voltage at the connection point by taking into account a grid impedance determined from a power grid analysis of the active grid converter at the connection point, thereby preventing flicker emissions of the AC-DC active grid converter.

18. An electrical load, comprising a converter, said converter comprising a DC-AC load converter for supplying an electrical load, an AC-DC active grid converter having a connection point connected to an electrical power grid, and a DC link connecting the DC-AC load converter and the AC-DC active grid converter and comprising at least one capacitor operating as an energy store, wherein the AC-DC active grid converter is controlled so that a grid current change at the connection point maintains a maximum permissible change of effective values of successive voltage half-cycles of a voltage at the connection point by taking into account a grid impedance determined from a power grid analysis of the active grid converter at the connection point, thereby preventing flicker emissions of the AC-DC active grid converter.

19. The electrical load of claim 18, embodied as an electric drive or a household appliance.
